(19) United States
(12) Patent Application Publication
(10) Pub. No.: US 2012/0001061 A1
(43) Pub. Date: Jan. 5, 2012

(54) ION IMPLANTED BEAM DUMP

(75) Inventor: Andrew J. Zillmer, West Hills, CA (US)

(73) Assignee: HAMILTON SUNDSTRAND CORPORATION, Windsor Locks, CT (US)

(21) Appl. No.: 12/829,657

(22) Filed: Jul. 2, 2010

(51) Int. Cl. G02B 27/10; G02B 5/22; B23P 11/00; G01D 5/34

(52) U.S. Cl. 250/216; 359/618; 359/614; 29/428

(57) ABSTRACT

An optical device is provided and includes a beam splitter disposed to direct a first portion of a light beam propagating along a first light path along a second light path transverse to the first light path and to permit a second portion of the light beam to propagate along a third light path oriented in line with the first light path and a beam dump disposed on the third light path and including a surface upon which the second light beam portion is incident, the beam dump surface having ion implantation defects formed thereon to absorb a substantial entirety of the second light beam portion.

### BACKGROUND OF THE INVENTION

The subject matter disclosed herein relates to an ion implanted beam dump.

Beam dumps absorb incident light and are used to capture unwanted beams. In laboratory settings, they are used to stop stray laser beams. In instrumentation settings, they are used to contain a beam within a portion of the instrument.

The absorptive property or anti-reflective property of a beam dump can be characterized by its apparent reflection factor. For example, incident light may be reflected twice off a black cone whose reflection factor determines the observed reflection of the unit. In this case, the lower the reflection factor, the more efficient the beam dump will be in absorbing the incident light. Thus, it is often a design goal for beam dump design to make beam dumps with reflection factors that are as low as possible.

Designing beam dumps with low reflection factors normally involves keeping the active surface clean of dust, grease and scratches. Such a beam bump is shown in FIG. 1 in which incident light 10 propagates toward and into a curved conical formation 20 that has been machined into a wall surface 30 and which may have been provided with a light absorptive layer on its active surface. The incident light is repeatedly reflected from wall to wall within the formation 20 and, eventually, a portion is absorbed such that an amount of reflected light 11 reflected from the wall surface 30 is substantially reduced in comparison with an amount of the incident light 10.

The structural integrity of the beam dump shown in FIG. 1 directly influences an amount of light reflected from the wall surface 30 as compared to an amount of light permitted to be absorbed within the formation 20 and it is, therefore, important that the size and shape of the formation 20 be highly tuned and well maintained. As such, initial assembly costs are often prohibitive. Also, it is typically necessary to clean the active surface by disassembling the beam dump and gently wiping down the active surface with a soft clean tissue. Here, precaution should be taken to avoid marking the active surface or otherwise degrading its structural integrity. Beam dump maintenance is, therefore, time consuming and difficult especially where the beam dump is a component of a device that is normally inaccessible or particularly sensitive, such as where the beam dump is installed in a telescope, a camera or a similarly sensitive optical device.

### BRIEF DESCRIPTION OF THE INVENTION

According to an aspect of the invention, an optical device is provided and includes a beam splitter disposed to direct a first portion of a light beam propagating along a first light path along a second light path transverse to the first light path and to permit a second portion of the light beam to propagate along a third light path oriented in line with the first light path and a beam dump disposed on the third light path and including a surface upon which the second light beam portion is incident, the beam dump surface having ion implantation defects formed thereon to absorb a substantial entirety of the second light beam portion.

According to another aspect of the invention, an optical device is provided and includes a main component defining a first light path along which a light beam propagates, a beam splitter disposed to direct a first portion of the light beam along a second light path transverse to the first light path and to permit a second portion of the light beam to propagate along a third light path oriented in line with the first light path, a detector disposed on the second light path to detect the first light beam portion and a beam dump disposed on the third light path and including a surface upon which the second light beam portion is incident, the beam dump surface having ion implantation macroscopic/physical defects formed thereon to absorb a substantial entirety of the second light beam portion.

According to yet another aspect of the invention, a method of assembling an optical device in which a beam splitter directs a first portion of a light beam propagating along a first light path along a second light path transverse to the first light path and permits a second portion of the light beam to propagate along a third light path oriented in line with the first light path is provided and includes exposing a surface of a beam dump to ion implantation to thereby form ion implantation defects thereon and disposing the beam dump on the third light path such that the second light beam portion is incident on the beam dump surface having the ion implantation defects.

According to yet another aspect of the invention, an optical telescope is provided and includes an eyepiece, a silvered mirror to reflect light toward the eyepiece, a housing to support the eyepiece and the silvered mirror and first and second beam dump components each having a beam dump component surface with ion implanted defects formed thereon, which are disposed at areas about the eyepiece and the silvered mirror, respectively, to absorb stray light.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a beam dump;

FIG. 2 is a schematic side sectional view of an optical device;

FIGS. 3-6 are exemplary ion implanted surfaces that may be incorporated into the optical device of FIG. 2; and

FIG. 7 is a schematic diagram of an exemplary optical telescope.

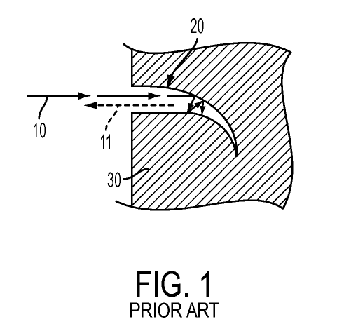

The detailed description explains embodiments of the invention, together with advantages and features, by way of example with reference to the drawings.

### DETAILED DESCRIPTION OF THE INVENTION

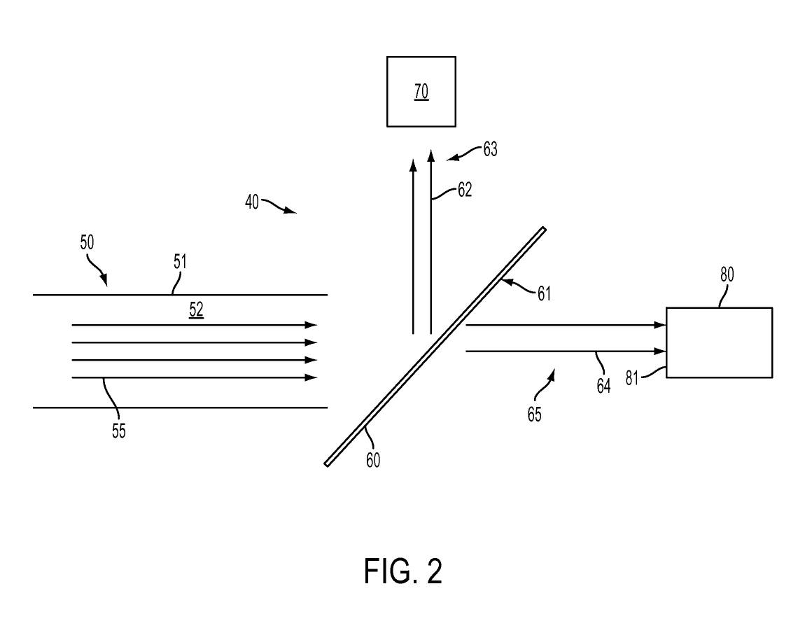

With reference to FIG. 2, an optical device 40, such as a telescope, an optical telescope, a camera or a photodetector is provided. The optical device 40 includes a main component 50 having a peripheral wall 51. The peripheral wall 51 defines a first light path 52 along which a light beam 55 propagates toward a beam splitter 60. The beam splitter 60 may be a silvered mirroring element, such as a half silvered mirror, a prismatic element or any other similar type of beam splitting device.

The beam splitter 60 is disposed on the first light path 52 and includes a beam splitter body 61. The beam splitter body 61 is configured to direct a first portion 62 of the light beam 55 (hereinafter referred to as “the first light beam portion 62”) along a second light path 63, which is oriented transversely with respect to the first light path 52. The beam splitter body 61 is further configured to permit a second portion 64 of the light beam 55 (hereinafter referred to as “the second light beam portion 64”) to propagate through the beam splitter body 61 and along a third light path 65, which is oriented substantially in line with the first light path 52. Of course, it is understood that this arrangement is merely exemplary and that other arrangements are possible.

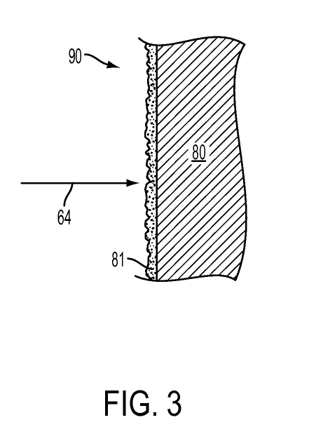

A detector 70 is disposed on the second light path 63 and is configured to receive and to detect light of the first light beam portion 62. In this way, the detector 70 may include a telescope eyepiece, a camera eyepiece or a photo detection unit of a photodetector. A beam dump 80 is disposed on the third light path 65 and includes a surface 81 upon which light of the second light beam portion 64 is incident. The beam dump surface 81 may be opaque and has ion implantation macroscopic/physical defects (see FIGS. 3-6) formed thereon to absorb a substantial entirety of the second light beam portion 64.

Ion implantation of beam dump surface 81 refers to the acceleration of ions, defined as atoms missing one or more electrons, such as C+, H+, Cs+, Li+, Ca+, N+, Ar+, Kr+, Xe+, H₂+, Na+ and/or K+ ions, toward beam dump surface 81 such that ions hitting the beam dump surface 81 cause a sputtering or some other similar surface modification of the material of the beam dump 80, which may be, for example, a metallic material or an alloy of a metallic material. The sputtering or surface modification leads to the formation of bumps, macroscopic/physical and/or other irregularities in the beam dump surface 81, which may have an outward coral-like appearance with the bumps and/or surface irregularities serving to increase an absorbtivity of the beam dump surface 81. This increased absorbtivity may be further increased with the beam dump surface 81 being opaque and with the additional use of absorbtive geometries, as will be discussed below. The effects of ion implantation are permanent as long as the beam dump surface 81 is not extensively fouled.

With reference to FIG. 3, the beam dump surface 81 may be opaque and may be formed as a substantially flat planar surface 90. Here, the third light path 65 and a propagation direction of the second light beam portion 64 are similarly oriented to be normal to a plane of the beam dump surface 81.

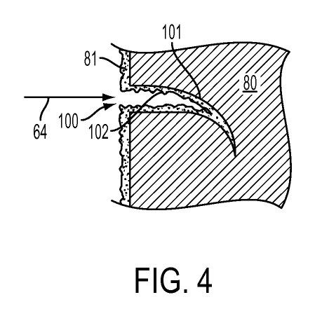

With reference to FIG. 4, the beam dump 80 and the beam dump surface 81 may be formed to define a horn shaped cavity 100. In this case, the beam dump 80 may include curved surfaces 101 whose shapes are mimicked by curved surfaces 102 of the beam dump surface 81. Again, the third light path 65 and a propagation direction of the second light beam portion 64 are similarly oriented to be normal to a plane of the beam dump surface 81. In this way, light of the second light portion 64 enters the cavity 100 and is reflected between curved surfaces 102 until it is substantially entirely absorbed.

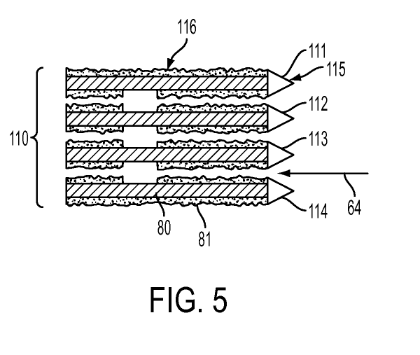

With reference to FIG. 5, the beam dump 80 and the beam dump surface 81 may be formed in a razor blade arrangement 110 as multiple adjacent blades 111, 112, 113 and 114. Here, each blade has lead surfaces 115 to direct light of the second light beam portion 64 in between the blades and side surfaces 116 on at least portions of which the ion implantation defects are formed such that the light can be absorbed between the blades. Again, the third light path 65 and a propagation direction of the second light beam portion 64 are similarly oriented to be normal to a plane of the beam dump surface 81. In alternative embodiments, the beam dump surface 81 may be positioned further back from the lead surfaces 115 or be configured as stripes so that light may be reflected down between the blades 111, 112, 113 and 114 and light scattered back will be absorbed.

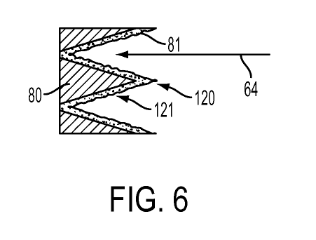

With reference to FIG. 6, the beam dump 80 and the beam dump surface 81 may be formed with conical structures 120 with angled surfaces 121 on which the ion implantation defects are formed such that the light can be absorbed at the angled surfaces 121. Again, the third light path 65 and a propagation direction of the second light beam portion 64 are similarly oriented to be normal to a plane of the beam dump surface 81.

In accordance with another aspect, a method of assembling a device, such as the optical device 10 described above, is provided and includes exposing a beam dump surface 81 to ion implantation to thereby form ion implantation defects thereon and disposing the beam dump 80 on the third light path 65 such that the second light beam portion 64 is incident on the beam dump surface 81 having the ion implantation defects. The method further includes forming the beam dump surface 81 to be opaque, the exposing includes implanting any one or more of C+, H+, Cs+, Li+, Ca+, N+, Ar+, Kr+, Xe+, H₂+, Na+ and/or K+ ions into the beam dump surface 81 and the disposing includes disposing the beam dump 80 such that a propagation direction of the second light beam portion 64 is normal to a plane of the beam dump surface 81.

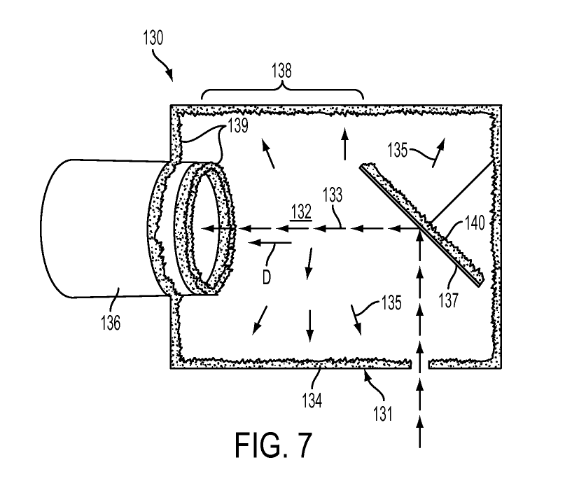

With reference to FIG. 7 and, in accordance with another aspect of the invention, an optical device 130, such as an optical telescope, a camera, a digital camera or a similar type of optical device, is provided and includes a housing 131 formed to define a pathway 132 along which light 133 propagates and a surface 134 with macroscopic/physical ion implanted defects formed thereon. The surface 134 is formed to be similar to the beam dump 80 described above and is displaced from the pathway 132 to absorb stray light 135, which is scattered from the light 133 propagating along the pathway 132.

In accordance with various embodiments, the surface 134 may surround the pathway 132 in a direction that is transverse to a predominant propagation direction, D, of the light 133. Further, the optical device 130 may include a detector 136, such as an eyepiece or film, and an optical element 137, such as a mirroring element, a half mirroring element or an objective lens, to focus or reflect the light 133 toward the detector 136 or another optical element 137. That is, the optical element 137 may be a single or plural features for integration in, for example, a camera having a serpentine light path.

The pathway 132 may be defined from at least the optical element 137 to the detector 136 and, in some cases, from a source inside or outside of the housing 131 to the optical element 137 and/or from the detector 136 to a target similarly inside or outside of the housing 131. The surface 134 may include at least first portions 138 disposed along and around the pathway 132, second portions 139 disposed at areas about the detector 136 and third portions 140 disposed at areas about the optical element 137 to absorb the stray light 135.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An optical device, comprising:
a beam splitter disposed to direct a first portion of a light beam propagating along a first light path along a second light path transverse to the first light path and to permit a second portion of the light beam to propagate along a third light path oriented in line with the first light path; and
a beam dump disposed on the third light path and including a surface upon which the second light beam portion is incident,
the beam dump surface having ion implantation defects formed thereon to absorb a substantial entirety of the second light beam portion.

2. The optical device according to claim 1, wherein the beam dump surface is opaque.

3. The optical device according to claim 1, wherein the beam dump surface is a substantially flat planar surface.

4. The optical device according to claim 2, wherein a propagation direction of the second light beam portion is normal to a plane of the beam dump surface.

5. The optical device according to claim 1, wherein the beam dump surface is formed to define horn shaped cavities with curved surfaces on which the ion implantation defects are formed.

6. The optical device according to claim 1, wherein the beam dump surface is formed as multiple adjacent blades in a razor blade arrangement, each blade having lead surfaces to direct the second light beam portion between the blades and side surfaces on at least portions of which the ion implantation defects are formed.

7. The optical device according to claim 1, wherein the beam dump surface is formed with conical structures with angled surfaces on which the ion implantation defects are formed.

8. An optical device, comprising:
a main component defining a first light path along which a light beam propagates;
a beam splitter disposed to direct a first portion of the light beam along a second light path transverse to the first light path and to permit a second portion of the light beam to propagate along a third light path oriented in line with the first light path;
a detector disposed on the second light path to detect the first light beam portion; and
a beam dump disposed on the third light path and including a surface upon which the second light beam portion is incident,
the beam dump surface having ion implantation macroscopic/physical defects formed thereon to absorb a substantial entirety of the second light beam portion.

9. The optical device according to claim 8, wherein the beam splitter comprises a silvered mirroring element.

10. The optical device according to claim 8, wherein the beam splitter comprises a prismatic element.

11. The optical device according to claim 8, wherein the beam dump surface is opaque.

12. The optical device according to claim 8, wherein the beam dump surface is a substantially flat planar surface.

13. The optical device according to claim 12, wherein a propagation direction of the second light beam portion is normal to a plane of the beam dump surface.

14. The optical device according to claim 8, wherein the beam dump surface is formed to define horn shaped cavities with curved surfaces on which the ion implantation defects are formed.

15. The optical device according to claim 8, wherein the beam dump surface is formed as multiple adjacent blades in a razor blade arrangement, each blade having lead surfaces to direct the second light beam portion between the blades and side surfaces on at least portions of which the ion implantation defects are formed.

16. The optical device according to claim 8, wherein the beam dump surface is formed with conical structures with angled surfaces on which the ion implantation defects are formed.

17. A method of assembling an optical device in which a beam splitter directs a first portion of a light beam propagating along a first light path along a second light path transverse to the first light path and permits a second portion of the light beam to propagate along a third light path oriented in line with the first light path, the method comprising:
exposing a surface of a beam dump to ion implantation to thereby form ion implantation defects thereon; and
disposing the beam dump on the third light path such that the second light beam portion is incident on the beam dump surface having the ion implantation defects.

18. The method according to claim 17, further comprising forming the beam dump surface to be opaque.

19. The method according to claim 17, wherein the exposing comprises implanting any one or more of C+, H+, Cs+, Li+, Ca+, N+, Ar+, Kr+, Xe+, H₂+, Na+ and/or K+ ions into the beam dump surface.

20. The method according to claim 17, wherein the disposing comprises disposing the beam dump on the third light path such that a propagation direction of the second light beam portion is normal to a plane of the beam dump surface.

21. An optical device, comprising:
a housing formed to define a pathway along which light propagates; and
a surface with ion implanted defects formed thereon, which is displaced from the pathway to absorb stray light scattered from the light propagating along the pathway.

22. The optical device according to claim 21, wherein the surface surrounds the pathway in a direction transverse to a propagation direction of the light.

23. The optical device according to claim 21, further comprising:
a detector; and
an optical element,
the pathway being defined from at least the optical element to the detector, and
the surface including portions thereof disposed at areas about the detector and the optical element.
